(19) United States
(12) Patent Application Publication
(10) Pub. No.: US 2019/0310766 A1
(43) Pub. Date: Oct. 10, 2019

(54) IDENTIFYING AND CREATING INDIVIDUAL ASSETS FROM A CANVAS

(71) Applicant: Adobe Inc., San Jose, CA (US)

(72) Inventors: Vivek Agrawal, Noida (IN); Tarun Gehlaut, Faridabad (IN); Prateek Soni, Jaipur (IN); Prashant Kumar Singh, Ghaziabad (IN); Ankit Aggarwal, Faridabad (IN)

(21) Appl. No.: 15/948,114

(22) Filed: Apr. 9, 2018

(51) Int. Cl. G06F 3/0484; G06F 17/21

(52) U.S. Cl. CPC G06F 3/04845; G06F 3/0486; G06F 17/211

(57) ABSTRACT

Systems and techniques for identifying and creating individual assets from a canvas containing an artwork include receiving a canvas containing an artwork. An organization of the artwork on the canvas is determined. Individual assets in the artwork on the canvas are identified by applying a segmentation rule based on the organization of the artwork. The individual assets are created.

### TECHNICAL FIELD

This description relates to the identification and creation of individual assets from a single canvas containing an artwork.

### BACKGROUND

Users, such as designers, using an application such as a design application may encounter technical challenges when attempting to export a design or a portion of the design. For example, the design application includes a canvas area on which the designer creates the design, which also may be referred to interchangeably as an artwork. The design, or artwork, may include multiple different assets that either form a part of the overall design or are individual design works in their own right. Typically, to export all of the multiple different assets as separate assets, the user must separately add each asset to a designated export panel. Simply selecting all of the assets in the artwork and adding them to the export panel creates a single composite asset instead of individual assets. This workflow presents challenges for designers having a design file with multiple assets that number in the thousands. To export these assets, the designer would have to individually select each asset, add it to the export panel and repeat the process for each of the thousands of assets. In this manner, the design application is not able to receive a selection of an entire canvas containing an artwork and to automatically identify and logically segment the artwork into separate, individual assets that then may be processed and handled on an individual basis, such as for an export function.

### SUMMARY

In one general aspect, a computer-implemented method for identifying and creating individual assets from a canvas containing an artwork includes receiving a canvas containing an artwork, determining an organization of the artwork on the canvas, identifying individual assets in the artwork on the canvas by applying a segmentation rule based on the organization of the artwork and creating the individual assets.

In another general aspect, a system for identifying and creating individual assets from a canvas containing an artwork includes at least one memory including instructions and at least one processor that is operably coupled to the at least one memory and that is arranged and configured to execute instructions that, when executed, cause the at least one processor to implement an application. The application includes a canvas containing an artwork and a segmentation module. The segmentation module is configured to receive the canvas containing the artwork, determine an organization of the artwork on the canvas, identify individual assets in the artwork on the canvas by applying a segmentation rule based on the organization of the artwork and create the individual assets.

In another general aspect, a computer program product for identifying and creating individual assets from a canvas containing an artwork is tangibly embodied on a computer-readable storage medium and includes instructions that, when executed by at least one computing device, are configured to cause the at least one computing device to receive a canvas containing an artwork, determine an organization of the artwork on the canvas, identify individual assets in the artwork on the canvas by applying a segmentation rule based on the organization of the artwork and create the individual assets.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for identifying and creating individual assets from a canvas containing an artwork.

FIG. 2 is a flowchart illustrating example operations of the system of FIG. 1.

FIG. 3 is an example screen shot illustrating a canvas of an application.

FIG. 4 is an example screen shot illustrating a canvas containing an artwork.

FIG. 5 is an example screenshot illustrating an export module.

FIG. 6 is an example screenshot illustrating a portion of a canvas containing an artwork and a context menu.

FIG. 7 is an example screenshot illustrating a layer hierarchy of multiple assets.

### DETAILED DESCRIPTION

This document describes systems and techniques for identifying and creating individual assets from a canvas containing an artwork. Such systems and techniques overcome technical challenges of previous systems and techniques and improve the process to work with and identify individual assets that are originally part of a group of assets as part of a single design. The systems and techniques automatically identify and logically segment individual assets from a single artwork on a single canvas. In order to automatically identify and segment the individual assets as separate assets, the system and techniques determine an organization of the artwork on the canvas. The system and techniques apply a segmentation rule that is selected based on the organization of the artwork to identify the individual assets and to create the individual assets.

The systems and techniques determine the organization of the artwork including whether the artwork is organized in a layer or group hierarchy, a distance-based clustering, or a combination of layer hierarchy and distance-based clustering. The segmentation rule selected to identify and segment the individual assets from each other depends on the type of organization of the artwork. If the artwork is organized in a layer hierarchy, the segmentation rule iterates over each layer and group of the canvas to segment a single asset from the artwork. If the assets are organized in a distance-based clustering, the segmentation rule applies a clustering algorithm using a distance threshold to segment a single asset from the artwork and from other assets on the artwork. If the assets are organized in both a layer hierarchy and a distance-based clustering, a combination of the above segmentation rule are applied. The details of how the system and techniques identify and create the individual assets are discussed in more detail below.

In this manner, a designer may use a simple selection technique to select an entire artwork on a canvas and have the artwork segregated into individual assets for separate processing and handling, such as applying an export function to each of the individual assets. For example, the export function allows each individual asset to be separately formatted and sized and designated for export outside of the design application. The system and techniques improve the computer functionality over what was once a manual user selection process, where the user manually identified each of the individual assets and separately dragged and dropped each particular asset to an export panel. The technical solution described in this document enables a single selection of an entire artwork and the system and techniques automatically identifies and segments the entire artwork into separate, individual assets. This new workflow automatically identifies and creates individual assets based on a layer hierarchy approach, a clustering algorithm approach using a distance between the assets, or a combination of the layer approach and the clustering algorithm approach. The system and techniques eliminate the manual, tedious approach to identifying individual assets for processing as individual assets such as for an export function.

In some implementations, the identification and creation of individual assets from a canvas containing an artwork may be accomplished in a single step. For instance, a single selection of a canvas containing the artwork may be dragged and dropped to an export module, which triggers the automatic identification and creation of the individual assets in the export module. In some implementations, a portion of the canvas containing the artwork, and thus a portion of the artwork, may be selected for segmentation into individual assets. For instance, a portion of the canvas containing a portion of the artwork may be dragged and dropped to an export module, which triggers the automatic identification and creation of the individual assets in the export module.

As used herein, a canvas refers to a user interface area of an application for creating a design. The canvas may be thought of as the digital workspace on which a design or an artwork is created. Multiple different design tools may be used to create the design on the canvas. The canvas is part of a single file. The canvas may fit on a single screen or span across multiple screens. The canvas may include a single design or multiple designs.

As used herein, an artwork refers to a design on a canvas. The artwork may include a single asset or multiple assets. In this manner, the artwork is an overall work of art that is a single file.

As used herein, an asset refers to an individual design or a portion of an individual design. Examples of assets include icons, logos, screen designs, art boards and any portion of a design or an artwork that may be separately identified and segmented out as an individual single asset.

As used herein, a clustering algorithm refers to an algorithm for clustering paths that are close enough to be considered as part of a single asset. One example of a clustering algorithm is a mean shift algorithm.

As used herein, a mean shift algorithm is a centroid-based algorithm, which works by updating candidates for centroids to be the mean of the points within a given region. These candidates are then filtered in a post-processing stage to eliminate near-duplicates to form the final set of centroids.

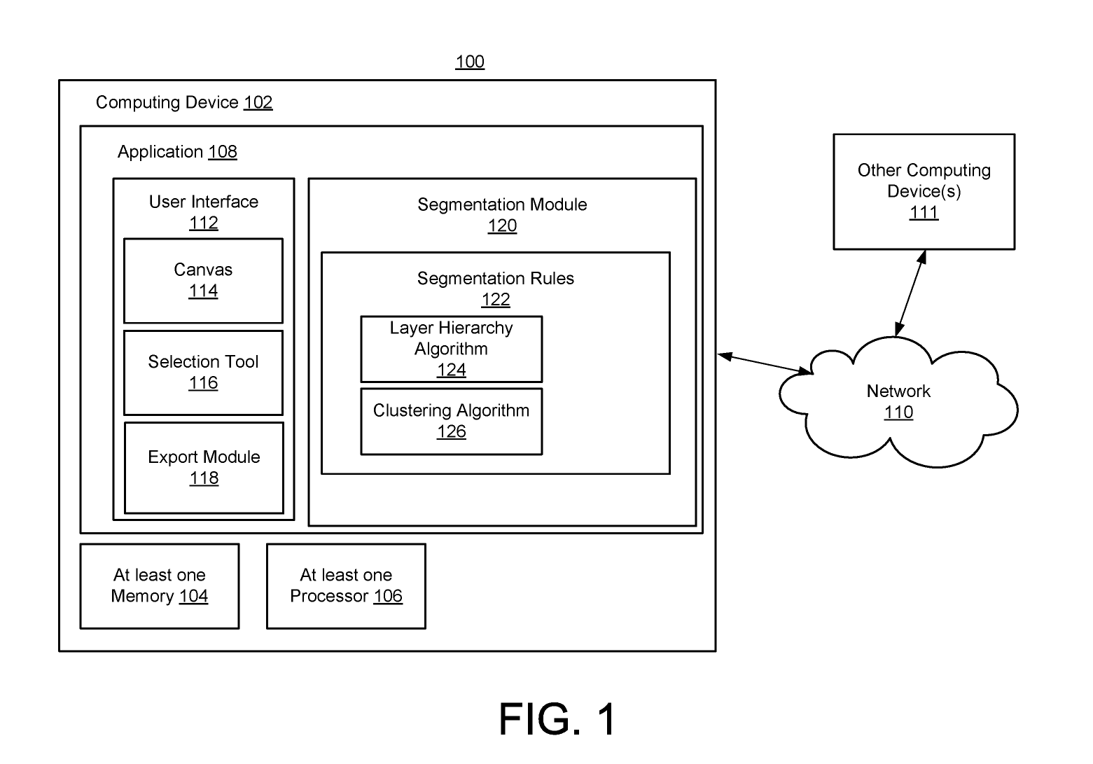

FIG. 1 is a block diagram of a system 100 for identifying and creating individual assets from a canvas containing an artwork. The system 100 includes a computing device 102 having at least one memory 104, at least one processor 106 and at least one application 108. The computing device 102 may communicate with one or more other computing devices 111 over a network 110. The computing device 102 may be implemented as a server, a desktop computer, a laptop computer, a mobile device such as a tablet device or mobile phone device, as well as other types of computing devices. Although a single computing device 102 is illustrated, the computing device 102 may be representative of multiple computing devices in communication with one another, such as multiple servers in communication with one another being utilized to perform its various functions over a network.

The at least one processor 106 may represent two or more processors on the computing device 102 executing in parallel and utilizing corresponding instructions stored using the at least one memory 104. The at least one memory 104 represents a non-transitory computer-readable storage medium. Of course, similarly, the at least one memory 104 may represent one or more different types of memory utilized by the computing device 102. In addition to storing instructions, which allow the at least one processor 106 to implement the application 108 and its various components, the at least one memory 104 may be used to store data, such as one or more of the objects or files generated by the application 108 and its components.

The network 110 may be implemented as the Internet, but may assume other different configurations. For example, the network 110 may include a wide area network (WAN), a local area network (LAN), a wireless network, an intranet, combinations of these networks, and other networks. Of course, although the network 110 is illustrated as a single network, the network 110 may be implemented as including multiple different networks.

The application 108 may be accessed directly by a user of the computing device 102. In other implementations, the application 108 may be running on the computing device 102 as a component of a cloud network where a user accesses the application 108 from another computing device, such other computing device(s) 111, over a network, such as the network 110. In one implementation, the application 108 may be a design application such as a graphic design application. The design application may be a standalone application that runs on the computing device 102. Alternatively, the design application may be an application that runs in another application such as a browser application or be a part of a suite of applications running in a cloud environment.

The application 108 enables a user to create and design many different kinds of graphics and layouts and artworks. The application 108 includes a user interface 112, where the user interface 112 includes a canvas 114, a selection tool 116, and an export module 118. The user interface 112 includes one or more areas, such as the canvas 114, and other interactive tools and windows for enabling a designer to create and manipulate a design, including an artwork.

The canvas 114 refers to an area of the user interface 112 for creating a design or artwork. Multiple different design tools may be used to create the design on the canvas. The canvas 114 is part of a single file. The canvas 114 may fit on a single screen or span across multiple screens. The canvas 114 may include a single design or multiple designs.

The canvas 114 may include an artwork, which includes multiple assets. In one implementation, a designer may desire to individually identify and segment one or more of the assets on the canvas 114. Once the assets have been individually identified and segmented, the designer may choose to manipulate them individually such as by exporting the individual assets. The designer may select the canvas 114 containing the artwork, or a portion of the canvas 114 containing a portion of the artwork, where the canvas 114 includes multiple assets within the single artwork. In some implementations, the selection tool 116 may be used to select the canvas 114 containing the artwork. The selection tool 116 may include one or more different tools for selecting the artwork. For instance, the selection tool 116 may generally refer to and include a drag and drop feature, a context menu selection item, a button, a shortcut menu, or other means for selecting the canvas 114 containing the artwork. In some implementations, the selection tool 116 also includes shift selecting desired assets from the artwork on the canvas 114; however, it may be more desirable to select by dragging and dropping the entire artwork to trigger the segmentation of individual assets from the one artwork.

In one implementation, the selection tool 116, in conjunction with the export module 118, may be used to trigger the application 108 to identify and create the individual assets as part of a single step. That is, when the designer designates the canvas 114 containing the artwork for export, then the application 108 proceeds to identify and segment the individual assets from the one artwork so that each asset may be separately exported. In some implementations, the selection tool 116 may operate in conjunction with other modules (not shown) to trigger the identification and creation of the individual assets as part of a single step. In some implementations, the simple selection of the portion of the canvas 114 containing the artwork automatically triggers the identification and creation of the individual assets without the need or cooperation of a separate function such as the export function provided by the export module 118 as part of a single step.

The application 108 performs the identification and creation of the individual assets using a segmentation module 120. The segmentation module 120 includes segmentation rules 122, which include a layer hierarchy algorithm 124 and a clustering algorithm 126. The segmentation module 120 performs the function of segmenting the individual assets from the artwork on the canvas 114. The segmentation module 120 receives the artwork on the canvas 114. The segmentation module 120 determines an organization of the artwork contained on the canvas 114. In other words, the segmentation module 120 determines how the assets in the artwork are organized in the file containing the canvas. The assets may be organized by a layer or grouping hierarchy, where there may be a single asset on a single layer and the canvas 114 may include multiple different layers, with each layer containing a single asset. The assets may be organized simply by distance-based clustering meaning that the individual assets are on a single layer of the canvas 114 separated by a distance from each other. That is, one asset may be located a certain distance from an adjacent asset. Also, the assets may be organized by both layer hierarchy and distance-based clustering. If those organization types are used to organize the assets, then multiple assets may be present in each layer.

The segmentation rules 122 may be applied individually or in combination based on the type of organization used in the file containing the canvas 114 and the artwork. The layer hierarchy algorithm 124 may be used when the artwork is organized in a layer or group hierarchy. The clustering algorithm 126 may be used when the artwork is organized by a distance-based clustering. Both the layer hierarchy algorithm 124 and the clustering algorithm 126 may be used when the artwork is organized in both a layer or group hierarchy and a distance-based clustering. Other segmentation rules 122 maybe developed and applied based on different types of organizations of the artwork on a canvas 114 within a single file.

When the artwork is organized in a layer or grouping hierarchy, the layer hierarchy algorithm 124 is applied to identify and create the individual assets. The layer hierarchy algorithm 124 begins by iterating over selected assets in the artwork tree on the canvas 114. During the traversal of the artwork, the segmentation of top level layers and groups is used to create individual assets from each such logical grouping.

When the artwork is organized by a distance-based clustering, the clustering algorithm 126 is applied to identify and create the individual assets. The clustering algorithm 126 begins the process of clustering to find logical groupings in the canvas 114 using a distance threshold. The distance threshold is a distance that separates one asset from another asset. In some implementations, the distance threshold may be a default computed value. In some implementations, the default computed value is user-configurable such that the user can increase and/or decrease the value. If a value is set and configured by the user, the user-specified value may be used for subsequent clustering algorithm operations.

In more detail, the clustering algorithm 126 may include a mean shift algorithm for clustering paths that are close enough to be considered as part of a single asset. In operation, the mean shift algorithm uses Bezier paths where all the segments of all the Bezier paths in the selection are reduced to their four (4) control points. The four control points are then added to a set, such as set A. Additionally a map, such as map B that maps the points to its Bezier path, is also maintained. The four control points are an approximation of the Bezier and the Bezier should be sampled for better results. The bandwidth parameter that corresponds to the distance threshold value for the algorithm is estimated using known techniques. The set A is passed to the mean shift algorithm, which divides the set A into several clusters. For each cluster that is obtained, then for every point in the cluster its corresponding Bezier is found using the reverse map B. This Bezier is then added to a group and becomes the individual asset. The user interface 112 may include a user interface control, such as a slider, that allows the user to adjust the bandwidth, which is the same as the distance threshold, to fine tune the results of segmenting multiple assets into individual assets. For example, the slider may be used to better capture and segment the individual assets from the artwork by changing the value for the threshold distance between the assets.

One feature of the application 108 includes the functionality of being able to export the individual assets using the export module 118. The export module 118 may be used as a trigger to automatically identify and create the individual assets, as mentioned above, and/or the export module 118 may be used as an example of the functionality to process individual assets after the individual assets are created. The export module 118 may include a user interface to display the individual assets and to allow feature selection of each individual asset independent of the other individual assets. The export module 118 enables the export of each individual asset in one or more different formats and one or more different sizes. Formats may include PNG, JPEG, SVG, PDF, and other formats. The individual assets may be exported to other files and/or file types within the application 108 and/or outside of the application 108. The export module 118 enables exporting individual assets to other computing devices, such as other computing device 111 across the network 110.

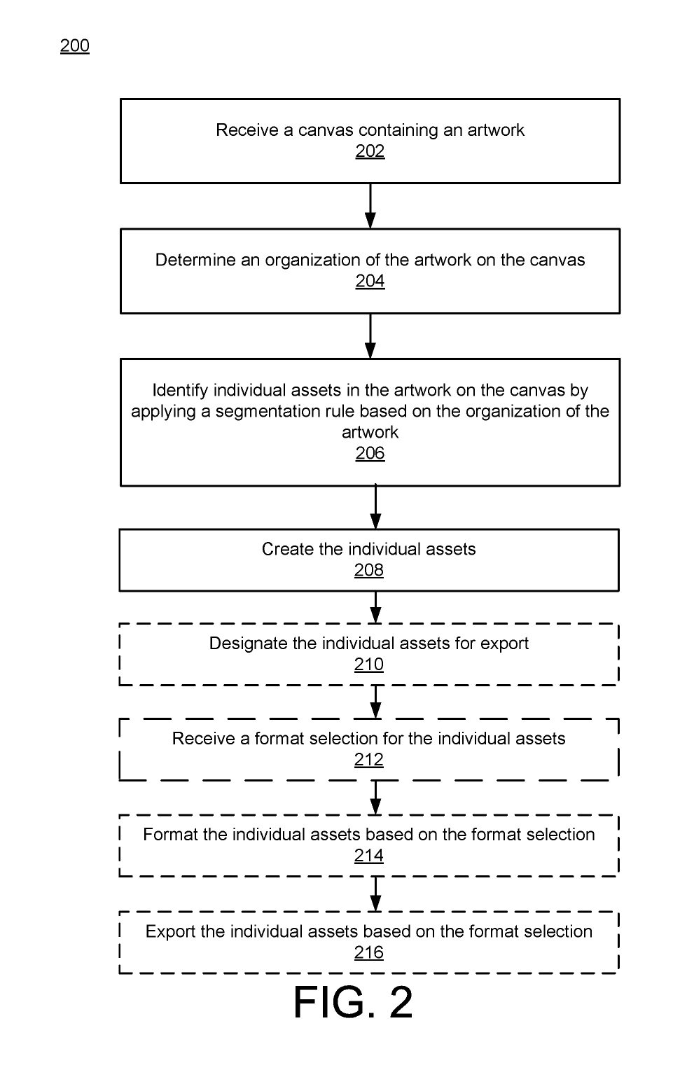

Referring to FIG. 2, process 200 illustrates example operations of the system of FIG. 1 for identifying and creating individual assets from a canvas containing an artwork. Process 200 includes receiving a canvas containing an artwork (202). For example, a designer may start by creating an artwork, which includes multiple assets as part of the single artwork file, such as multiple icon designs or multiple art boards, which the designer wants to export. With reference to FIG. 1, the designer may open the application 108 and open an existing file containing the artwork for display on the canvas 114 or may create the artwork in a new file for the canvas 114.

The segmentation module 120 receives the canvas 114 containing the artwork. In some implementations, the segmentation module 120 receives a portion of the canvas 114 containing a portion of the artwork. In some implementations, the selection tool 116 may be used to select the entire canvas 114 including the entire artwork on the canvas using a shortcut, such as a control plus a, or marquee selection, or by shift selecting the relevant icons.

Process 200 includes determining an organization of the artwork contained on the canvas (204). For example, the segmentation module 120 determines the organization of the artwork contained on the canvas 114. As discussed in detail above with respect to FIG. 1, the artwork may be organized in a layer or grouping hierarchy, a distance-based clustering, or a combination of the layer or group hierarchy and the distance-based clustering. Determining the organization of the artwork includes determining if the artwork is organized in a layer hierarchy, a distance-based clustering, or a combination of both a layer hierarchy and a distance-based clustering.

The segmentation module 120 may query user preferences for the application 108 to determine if a layer hierarchy preference is enabled. The layer hierarchy preference is used by the segmentation module 120 to determine if the artwork is organized in a layer or grouping hierarchy. In some implementations, the selection of the artwork may include a modifier key or context menu selection to identify the particular hierarchy of the artwork.

Process 200 includes identifying individual assets in the artwork on the canvas by applying a segmentation rule based on the organization of the artwork (206). For example, with respect to FIG. 1, the segmentation module 120 applies one or more of the segmentation rules 122 depending upon the organization of the artwork as determined by the segmentation module 120. Each of the different types of organization of the artwork may include its own segmentation rule that may be applied individually or in combination with other rules. If only layer hierarchy is used then the segmentation module applies the layer hierarchy algorithm 124. The segmentation module applies the layer hierarchy algorithm 124 by iterating over selected items in the artwork tree on the canvas 114. During the traversal of the artwork, the segmentation of top level layers and groups is used to create individual assets from each such logical grouping. If only distance-based clustering is used, then the segmentation module 120 applies the clustering algorithm 126. The clustering algorithm 126 begins the process of clustering to find logical groupings in the selection using the distance threshold, as discussed above with respect to FIG. 1.

If both the layer hierarchy and the distance-based clustering are used, the segmentation module 120 applies the segmentation rules 122 including both the layer hierarchy algorithm 124 and the clustering algorithm 126. In this manner, the selected layers are found and within each selected layer the clustering algorithm 126 is applied to find the individual assets within each layer.

Process 200 includes creating the individual assets (208). Once the individual assets have been identified, then the individual assets are created for use in other manners. With respect to FIG. 1, the segmentation module 120 creates the individual assets after identifying the individual assets. The individual assets may then be processed in various ways including labelling each asset and storing each asset for immediate and or later use.

Process 200 includes optional steps such as designating the individual assets for export (210), receiving a format selection for the individual assets (212), formatting the individual assets based on the format selection (214). And exporting the individual assets based on the format selection (216). As discussed above, one example context for identifying and creating individual assets from a canvas containing multiple assets is for exporting the individual assets. In some implementations, the process 200 to identify and create the individual assets may be triggered by the designation of the individual assets for export (210). In some implementations, designating the individual assets for export (210) may be subsequent to the identification and creation of the individual assets.

With respect to FIG. 1, the export module 118 may be used to designate the individual assets for export (210). As discussed above, the export module 118 is a user interface that enables the manipulation and processing of the individual assets for export. The export module 118 also enables application of one or more various features to the individual assets. For instance, the export module 118 can receive a format selection for the individual assets (212) and format the individual assets based on the format selection (214). Various formats for the assets include PNG, SVG, JPG, PDF and other format types. Other features provided by the export module 118 include a scaling factor, a location to save or store the exported files, a suffix to enable output files have a unique name, a prefix string, and other presets specifically for different types of operating systems.

Following the format selection and formatting of the individual assets, the export module 118 also exports the individual assets based on the format selection (216) and any other selected features. The export of the individual assets may create individuals files of each asset that may be separately stored to a file in the memory 104 of the computing device 102 and/or that may be communicated to other applications on the computing device 102. The individual assets also may be communicated to other computing devices, such as other computing device 111 using the network 110.

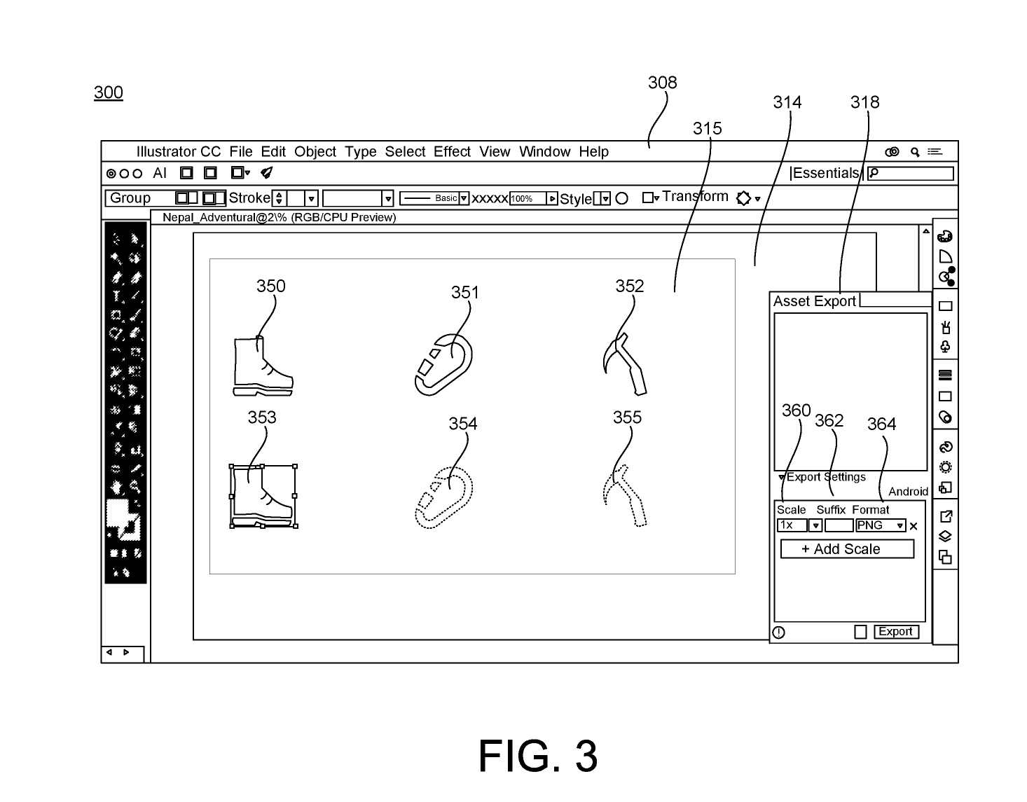

Referring to FIG. 3, an example screen shot 300 illustrates an example application 308 having a canvas 314 and an export module 318. In this screen shot 300, the application 308, the canvas 314 and the export module 318 correspond to and include all of the features and functionality of the application 108, the canvas 114 and the export module 118 of FIG. 1, as described throughout this document. For instance, the application 308 is a design application that provides features and functionality for a designer to create and manipulate designs. In this example, the canvas 314 includes an artwork 315 having multiple different assets 350-355, which in this example are icons. The application 308 and the process 200 of FIG. 2 enable these multiple assets 350-355 to be automatically identified and created as individual assets from the single artwork 315 so that the individual assets can be further processed on an individual basis, including exporting using the export module 318.

In this example, the application 308 would also include a segmentation module, such as the segmentation module 120 of FIG. 1 to perform the identification and creation of the individual assets from the artwork 315 on the canvas 314. For instance, the segmentation module would receive the artwork 315 on the canvas 314 that contains the multiple assets 350-355 that are desired by the designer to be manipulated as individual assets. The designer may use a keyboard shortcut to select the artwork 315 or a drop down selection menu or a right mouse click on the canvas 314 along with a selection of the canvas 314, or other selection operation to make the selection of the entire canvas 314. In some implementations, the artwork 315 on the canvas 314 may be dragged and dropped to the export module 118, which triggers the automatic identification and creation of the individual assets from the artwork 315. In this manner, the entire artwork may be dragged and dropped as a group to the export module 318, which triggers the automatic identification and creation of those assets 350-355 in the group as individual assets. While only six (6) assets are illustrated in this example, the canvas 314 may include thousands of assets that all may be selected for automatic identification and creation as individual assets.

The segmentation module determines how the artwork 315 is organized. That is, as discussed above, the artwork 315 may be organized in a layer hierarchy or in a distance-based clustering or a combination of both. The segmentation module then applies one or more segmentation rules based on the organization of the artwork 315 to identify and create the individual assets 350-355. If the artwork 315 is organized in a layer hierarchy, then the applied segmentation rule includes a layer hierarchy algorithm, such as layer hierarchy algorithm 124 of FIG. 1, that iterates over each layer of the canvas 314 to identify and create the assets 350-355 as individual assets. If the artwork 315 is organized in a distance-based clustering, then the applied segmentation rule applies a clustering algorithm, such as clustering algorithm 126 of FIG. 1, using a distance threshold to identify and create the assets 350-355 as individual assets. The distance threshold may be a default distance or a user-configured distance. The distance threshold is used as part of the clustering algorithm to separate the multiple assets 350-355 and identify one distinct asset from another distinct asset based on the distance apart of the assets from each other.

In the screenshot 300, the export module 318 illustrates various settings and features, as discussed above. For instance, the export module 318 includes a scale feature 360 to scale the size of an individual asset, a suffix feature 362 to add a suffix to label and identify an individual asset and a format feature 364 to select a format for an individual asset. Each of the settings and features may be applied separately to each individual asset in the export module 318. For example, one asset in the export module 318 may have one format export and a different asset in the export module 318 may have a different format for export.

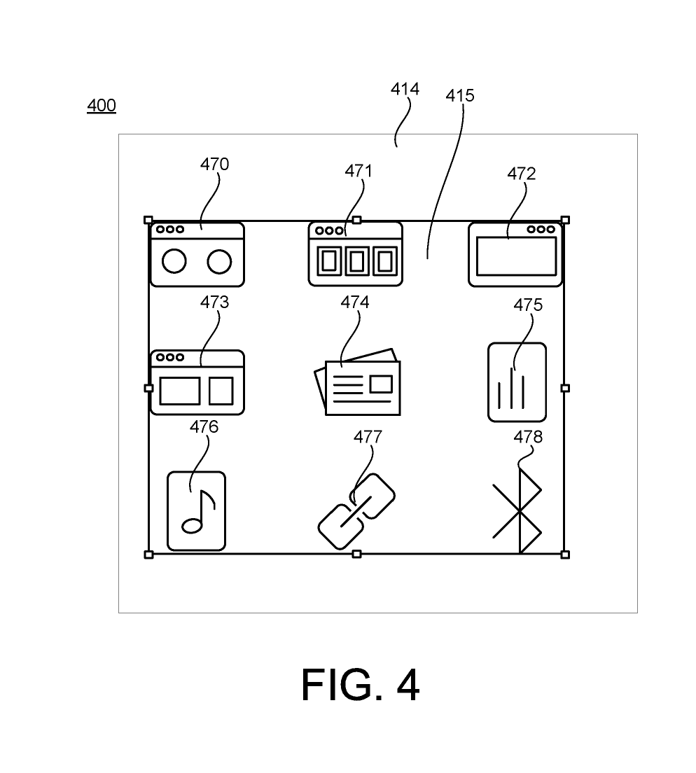

Referring to FIG. 4, an example screenshot 400 illustrates a portion of a canvas 414 containing an artwork 415 having multiple assets 470-478. In the example screenshot 400, the potion of the canvas 414 includes the same features and functionality discussed above with respect to the canvas 114 of FIG. 1. Here, the designer has selected the artwork 415 having multiple assets 470-478 on the canvas 414. The multiple assets 470-478 are not segmented into individual assets on the canvas 414. Instead, the multiple assets 470-478 are part of a single artwork 415, which may be a single file. Once selected, as discussed above, the segmentation module 120 of FIG. 1 applies the appropriate segmentation rule(s) 122 of FIG. 1 to segment the artwork 415 having the multiple assets 470-478 into individual assets. In this example, the artwork 415 is organized using distance-based clustering, meaning that the designer did not organize the assets 470-478 using layers, but instead simply placed the assets 470-478 in locations in the artwork 415 on the canvas 414 with each asset separated by some distance from the other assets. The segmentation module 120 applies a clustering algorithm, such as clustering algorithm 126 of FIG. 1, using a distance threshold to identify and create the assets as individual assets. The distance threshold may be a default distance or a user-configured distance.

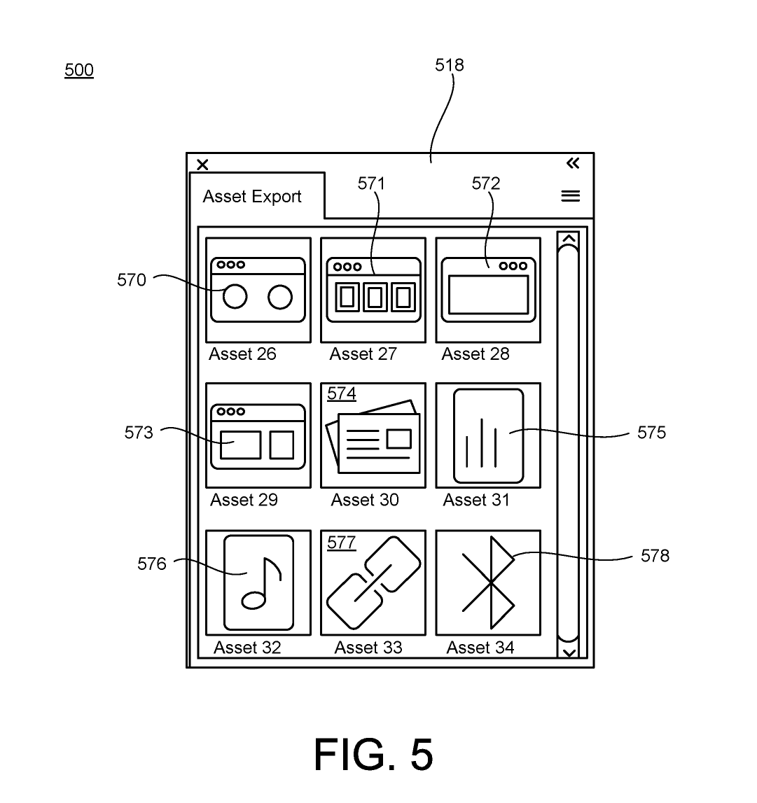

Referring also to FIG. 5, the example screenshot 500 illustrates an export module 518 with the assets 470-478 of FIG. 4 identified and separated as individual assets 570-578. In this example, the export module 518 includes all the features and functionality of the export module 118 of FIG. 1. Here, the segmentation module 120 of FIG. 1, received the artwork 415 having the assets 470-478 on the canvas 414, determined the organization of the artwork 415 and identified and created the individual assets 570-578 by applying the segmentation rule 122 based on the organization of the artwork 415. In this manner, a single artwork 415, which may be a single file, is segmented into its individual assets 570-578, which each may be a single file that may be separately processed, such as separately exported.

As individual assets 570-578, the user may apply one or more of the export features to each of the individual assets 570-578 separately and then export the individual assets 570-578. Each of the individual assets 570-578 is separately selectable for applying features and exporting. Multiple individual assets 570-578 may be selected at a same time to apply one or more of the same features and to export the individual assets 570-578. Each of the individual assets 570-578 may be assigned unique file names for storing and exporting.

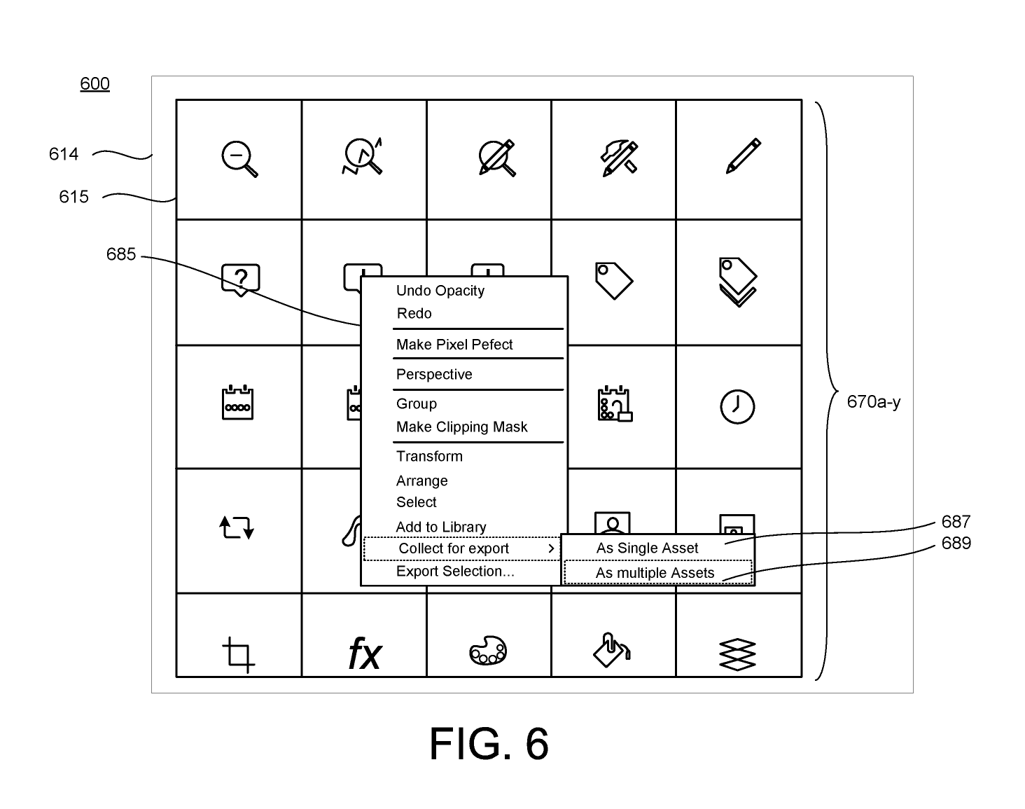

Referring to FIG. 6, an example screenshot 600 illustrates a portion of a canvas 614 containing an artwork 615 having multiple assets 670a-y and a context menu 685. In this example, the portion of the canvas 614 includes all the features and functionality of the canvas 114 of FIG. 1. In some implementations, a selection tool, such as selection tool 116 of FIG. 1, may be used to select the artwork 615. The context menu 685 may include options for how to process the artwork 615 when segmenting the multiple assets 670a-y in the artwork 615 into individual assets in the context of exporting the multiple assets 670a-y. For instance, the context menu 685 includes an option to collect the multiple assets for export as a single asset 687 or as multiple individual assets 689. If the single asset 687 option is selected, then the group of multiple assets 670a-y is designated for export all together as a single asset and not as individual assets using the export module, such as export module 118 of FIG. 1. If the multiple assets 689 option is selected, then the segmentation module, such as segmentation module 120 of FIG. 1, identifies and creates individuals assets for export in the export module 118 from the group of multiple assets 670a-y.

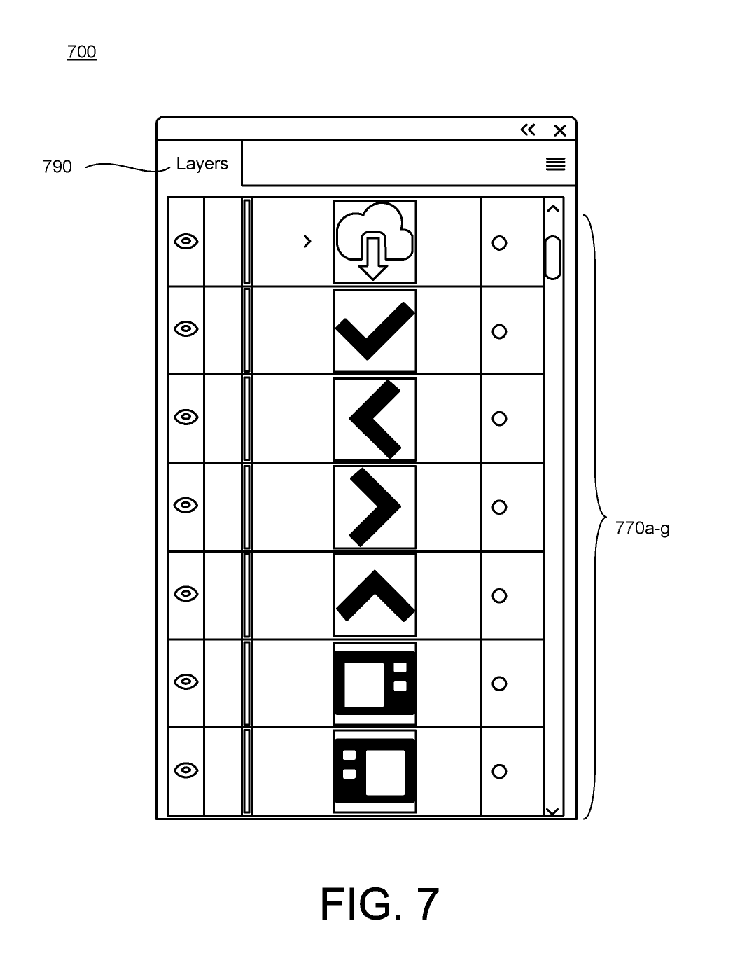

Referring to FIG. 7, an example screenshot 700 illustrates a layer hierarchy 790 of multiple assets 770a-g. As discussed above, the multiple assets 770a-g on a canvas may be organized in different ways. One way to organize the assets is by layer, where one or more assets may be created on a layer of the canvas. In this example, the multiple assets 770a-g are organized with a single asset per layer. When the assets are organized in this manner, the segmentation module 120 of FIG. 1 applies the layer hierarchy algorithm 124 from the segmentation rules 122 to identify and create individual assets from the group of multiple assets 770a-g.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for identifying and creating individual assets from a canvas containing an artwork, the method comprising:
receiving a canvas containing an artwork;
determining an organization of the artwork on the canvas;
identifying individual assets in the artwork on the canvas by applying a segmentation rule based on the organization of the artwork; and
creating the individual assets.

2. The method as in claim 1, further comprising:
designating the individual assets for export;
receiving a format selection for the individual assets;
formatting the individual assets based on the format selection; and
exporting the individual assets based on the format selection.

3. The method as in claim 1, wherein:
determining the organization of the artwork on the canvas includes determining the artwork is organized in a layer hierarchy;
the segmentation rule for the layer hierarchy includes iterating over each layer and group of the canvas to segment a single asset from the artwork; and
identifying the individual assets includes applying the segmentation rule for the layer hierarchy for each layer of the artwork on the canvas.

4. The method as in claim 1, wherein:
determining the organization of the artwork includes determining the artwork is organized in a distance-based clustering;
the segmentation rule for the distance-based clustering includes a clustering algorithm using a distance threshold to segment a single asset from the artwork; and
identifying the individual assets includes applying the segmentation rule for the distance-based clustering for the artwork on the canvas.

5. The method as in claim 4, wherein the distance threshold is user-configurable.

6. The method as in claim 4, wherein the clustering algorithm includes a Mean Shift algorithm.

7. The method as in claim 1, wherein:
determining the organization of the artwork includes determining the artwork is organized in both a layer hierarchy and a distance-based clustering;
the segmentation rule for the layer hierarchy includes iterating over each layer and group of the canvas to segment a single asset from the artwork;
the segmentation rule for the distance-based clustering includes a clustering algorithm using a distance threshold to segment a single asset from the artwork; and
identifying the individual assets includes applying the segmentation rule for the layer hierarchy and applying the segmentation rule for the distance-based clustering for each layer of the artwork on the canvas.

8. A system for identifying and creating individual assets from a canvas containing an artwork, the system comprising:
at least one memory including instructions; and
at least one processor that is operably coupled to the at least one memory and that is arranged and configured to execute instructions that, when executed, cause the at least one processor to implement an application, the application comprising:
a canvas containing an artwork; and
a segmentation module, wherein the segmentation module is configured to:
receive the canvas containing the artwork;
determine an organization of the artwork on the canvas;
identify individual assets in the artwork on the canvas by applying a segmentation rule based on the organization of the artwork; and
create the individual assets.

9. The system of claim 8, wherein the application further comprises an export module that is configured to:
designate the individual assets for export;
receive a format selection for the individual assets;
format the individual assets based on the format selection; and
export the individual assets based on the format selection.

10. The system of claim 8, wherein:
determining the organization of the artwork includes determining the artwork is organized in a layer hierarchy;
the segmentation rule for the layer hierarchy includes iterating over each layer and group of the canvas to segment a single asset from the artwork; and
identifying the individual assets includes applying the segmentation rule for the layer hierarchy for each layer of the artwork on the canvas.

11. The system of claim 8, wherein:
determining the organization of the artwork includes determining the artwork is organized in a distance-based clustering;
the segmentation rule for the distance-based clustering includes a clustering algorithm using a distance threshold to segment a single asset from the artwork; and
identifying the individual assets includes applying the segmentation rule for the distance-based clustering for the artwork on the canvas.

12. The system of claim 11, wherein the distance threshold is user-configurable.

13. The system of claim 11, wherein the clustering algorithm includes a Mean Shift algorithm.

14. The system of claim 8, wherein:
determining the organization of the artwork includes determining the artwork is organized in both a layer hierarchy and a distance-based clustering;
the segmentation rule for the layer hierarchy includes iterating over each layer and group of the canvas to segment a single asset from the artwork;
the segmentation rule for the distance-based clustering includes a clustering algorithm using a distance threshold to segment a single asset from the artwork; and
identifying the individual assets includes applying the segmentation rule for the layer hierarchy and applying the segmentation rule for the distance-based clustering for each layer of the artwork on the canvas.

15. A computer program product for identifying and creating individual assets from a canvas containing an artwork, the computer program product being tangibly embodied on a computer-readable storage medium and comprising instructions that, when executed by at least one computing device, are configured to cause the at least one computing device to:
receive a canvas containing an artwork;
determine an organization of the artwork on the canvas;
identify individual assets in the artwork on the canvas by applying a segmentation rule based on the organization of the artwork; and
create the individual assets.

16. The computer program product of claim 15, further comprising instructions that, when executed by the at least one computing device, are configured to cause the at least one computing device to:
designate the individual assets for export;
receive a format selection for the individual assets;
format the individual assets based on the format selection; and
export the individual assets based on the format selection.

17. The computer program product of claim 15, wherein:
the instructions that, when executed by the at least one computing device, are configured to cause the at least one computing device to determine the organization of the artwork include instructions that, when executed by the at least one computing device, are configured cause the at least one computing device to determine the artwork is organized in a layer hierarchy;
the segmentation rule for the layer hierarchy includes iterating over each layer and group of the canvas to segment a single asset from the artwork; and
the instructions that, when executed by the at least one computing device, are configured to cause the at least one computing device to identify the individual assets include instructions that, when executed by the at least one computing device, are configured cause the at least one computing device to apply the segmentation rule for the layer hierarchy for each layer of the artwork on the canvas.

18. The computer program product of claim 15, wherein:
the instructions that, when executed by the at least one computing device, are configured to cause the at least one computing device to determine the organization of the artwork include instructions that, when executed by the at least one computing device, are configured cause the at least one computing device to determine the artwork is organized in a distance-based clustering;
the segmentation rule for the distance-based clustering includes a clustering algorithm using a distance threshold to segment a single asset from the artwork; and
the instructions that, when executed by the at least one computing device, are configured to cause the at least one computing device to identify the individual assets include instructions that, when executed by the at least one computing device, are configured cause the at least one computing device to apply the segmentation rule for the distance-based clustering for the artwork on the canvas.

19. The computer program product of claim 18, wherein the distance threshold is user-configurable.

20. The computer program product of claim 15, wherein:
the instructions that, when executed by the at least one computing device, are configured to cause the at least one computing device to determine the organization of the artwork include instructions that, when executed by the at least one computing device, are configured cause the at least one computing device to determine the artwork is organized in both a layer hierarchy and a distance-based clustering;
the segmentation rule for the layer hierarchy includes iterating over each layer and group of the canvas to segment a single asset from the artwork;
the segmentation rule for the distance-based clustering includes a clustering algorithm using a distance threshold to segment a single asset from the artwork; and
the instructions that, when executed by the at least one computing device, are configured to cause the at least one computing device to identify the individual assets include instructions that, when executed by the at least one computing device, are configured cause the at least one computing device to apply the segmentation rule for the layer hierarchy and apply the segmentation rule for the distance-based clustering for each layer of the artwork on the canvas.
